(19) United States
(12) Patent Application Publication
(10) Pub. No.: US 2007/0115083 A1
(43) Pub. Date: May 24, 2007

(54) Low-voltage circuit-breaker with an electronic overload trip and trip magnets

(76) Inventors: Henry Franke, Berlin (DE); Gernot Gunther, Berlin (DE); Jeffery C. Mizener, Sidney, OH (US); Aron-Ernst Musiol, Mahlow (DE); Gunter Prietzel, Berlin (DE)

Correspondence Address: HARNESS, DICKEY & PIERCE, P.L.C., P.O.BOX 8910, RESTON, VA, 20195, US

(21) Appl. No.: 10/480,442

(22) PCT Filed: Jun. 4, 2002
(86) PCT No.: PCT/DE02/02082

§ 371 Date: Jul. 2, 2004

(30) Foreign Application Priority Data
Jun. 13, 2001 (DE) 201 09 898.9

(51) Int. Cl. H01F 7/02

(52) U.S. Cl. 335/302

(57) ABSTRACT

A low voltage circuit breaker includes an electronic trip and trip magnets. A trip magnet is controlled by an overload trip and a further trip magnet, such as a low voltage trip or a working current trip. The trip magnets are mounted on a rear face, facing away from the operating front of the electronic trip. In the same section of the operating field, display and reset devices are accessible to the user.

This application is the national phase under 35 U.S.C. §371 of PCT International Application No. PCT/DE02/02082 which has an International filing date of Jun. 4, 2002, which designated the United States of America and which claims priority on German Patent Application number DE 201 09 898.9 filed Jun. 13, 2001, the entire contents of which are hereby incorporated herein by reference.

### FIELD OF THE INVENTION

The invention generally relates to a low-voltage power breaker having an electronic overcurrent release and having tripping magnets. Preferably, when the overcurrent release or a special signal causes the closed switching contacts to be released, the tripping magnets trip a latch. The overcurrent release and the tripping magnets may be fit together to form one protective module.

### BACKGROUND OF THE INVENTION

A power breaker has been disclosed in U.S. Pat. No. 4,700,161. This power breaker has a known compact design having a molded case and a toggle lever drive (MCCB). In order to make it possible to replace or refit modules of the tripping magnets, access can be gained to said tripping magnets via the front control panel of the power breaker once a cover has been removed. The electronic overcurrent release does not have its own control panel owing to the compact design of the power breaker. Another feature of the design of compact power breakers is the fact that the operator can detect a tripping procedure not by means of a special display element but by means of a specific position of the outer handle of the toggle lever drive. The resetting required for reconnection of the power breaker also takes place by means of the handle of the toggle lever drive.

Electronic overcurrent releases and tripping magnets are correspondingly used in the same manner in low-voltage power breakers of open design (PCBs) which are distinguished from the design with the toggle lever drive by their suitability for higher rated currents and by their higher switching capacity as well as by a storage drive. The overcurrent releases of these power breakers also make it possible to set all the important parameters in order to be able to match the protective action of the power breaker, for example, to the properties of a load. For this purpose, the overcurrent releases are provided with their own front control panel which is included in the control panel of the power breaker and at which access can be gained to the setting elements. Resetting, following tripping, takes place in this case by means of a special element which is arranged in the vicinity of the front control panel of the overcurrent release (Catalog 3WN6, 1995, page 2, Siemens Publication E20002-K1801-B401-A1).

### SUMMARY OF THE INVENTION

An embodiment of the invention may be based on an object, in a power breaker, of accommodating tripping magnets in a space-saving manner. Preferably, their display and reset elements are arranged on the front control panel of the power breaker such that they can be seen.

An object may be achieved according to an embodiment of the invention by the electronic overcurrent release having, in a manner known per se, a front control panel which is accessible via a control panel of the power breaker, and/or by the tripping magnets being fit to the overcurrent release on the side of a housing of the latter that is remote from the front control panel.

Using an arrangement which is the opposite of that disclosed in U.S. Pat. No. 4,700,161, mentioned initially,—tripping magnets underneath or behind the electronic overcurrent release—the user may operate the electronic overcurrent release in the same manner whilst retaining the advantage of the combined design of the two assemblies. On the other hand, the display and operating elements of the tripping magnets are now part of the front control panel of the overcurrent release, which improves clarity and thus operational reliability. An important factor here is the fact that the combination of all of the tripping magnets provided to form a assembly fit to the overcurrent release accordingly also makes two, or even more, display and reset elements visible and accessible to the operator on the front control panel of the overcurrent release.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention, and wherein:

FIG. 1 shows a side view of a protective module comprising an electronic overcurrent release and an assembly of tripping magnets.

FIG. 2 shows the upper part of a front control panel of the protective module shown in FIG. 1.

### DETAILED DESCRIPTION OF THE PREFERRED EMBODIMENTS

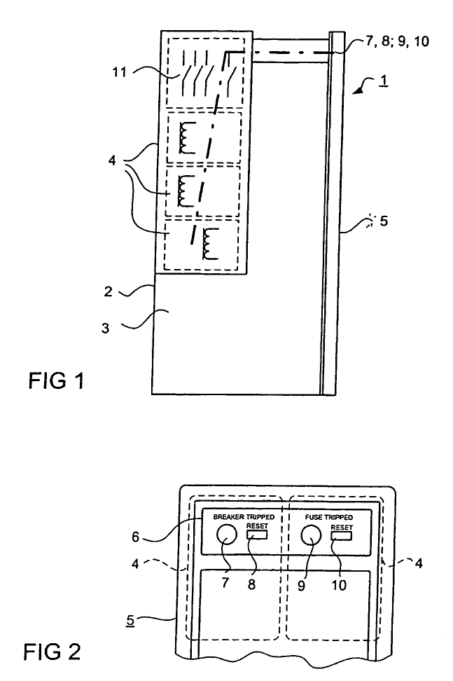

The protective module 1 shown in FIG. 1 comprises an electronic overcurrent release 2, whose housing 3 is stepped such that tripping magnets 4 can be located wholly or partially in the step. The tripping magnets are combined in a known manner to form a magnet assembly. In particular, a tripping magnet, which can be activated by the overcurrent release 2, as well as an undervoltage release and an operating current release can be provided. These additional tripping magnets can be activated by dedicated circuits. However, it is possible, for example, to register the response of such additional tripping magnets in a memory module of the electronic overcurrent release 2.

A special panel 6 for operating the tripping magnets is located on a front control panel 5 of the protective module 1 which is shown separately in FIG. 2, in section and from the front. In the example shown, a display element 7 and a reset element 8 for the tripping magnet 8 influenced by the overcurrent release are provided, and identical display and operating elements 9 and 10, respectively, for an operating current release which can be energized, for example, when a high breaking capacity fuse, which is connected in series with the power breaker, blows.

The magnet assembly shown in FIG. 1 having the tripping magnets 4 may be fit with components as required, as is known per se, and may additionally have signaling switches 11 in order not only to be able to indicate response of the tripping magnets 4 mechanically but also to be able to signal this electrically. The fact that the control panel 5 protrudes slightly beyond the housing 3, and pins and plungers for display and resetting purposes can be arranged through said housing 3 from the magnet assembly, which also protrudes slightly beyond the housing 3, makes it possible for the tripping magnets 4 arranged at the rear of the housing 3 to interact without problems with the display and reset elements located on the front control panel 5.

If required, the display and reset elements of more than two tripping magnets 4 can also be arranged in the display panel 6. If, as indicated in FIG. 2, tripping magnets 4 are arranged next to one another, this makes it easier to accommodate the display and reset elements 7, 9 and 8 and 10, respectively. The low-voltage power breaker, which is fit with the protective module, has not been shown specifically in the figures since it has a design which is known per se, for example according to the abovementioned Siemens document. The interaction of the tripping magnets 4 with the latch elements in the breaker mechanism of the power breaker takes place in the same manner as for known power breakers.

### LIST OF REFERENCE NUMERALS

1 Protective module
2 Electronic overcurrent release
3 Housing of the overcurrent release 2
4 Tripping magnet
5 Front control panel of the overcurrent release 2
6 Front control panel for tripping magnets 4
7,9 Display element for tripping magnet
8,10 Reset element for tripping magnet
11 Signaling switch

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A low-voltage power breaker, comprising:
an electronic overcurrent release; and tripping magnets, adapted to trip a latch when at least one of the electronic overcurrent release and a special signal causes closed switching contacts to be released, the electronic overcurrent release and the tripping magnets being fit together to form a protective module, wherein
the electronic overcurrent release includes a front control panel, accessible via a control panel of the power breaker, and wherein the tripping magnets are fit to the electronic overcurrent release on a side of a housing of the electronic overcurrent release that is remote from the front control panel.

2. The low-voltage power breaker as claimed in claim 1, wherein
the tripping magnets include at least one of display and reset elements, visible on the front control panel of the electronic overcurrent release.

3. A module of a circuit breaker, comprising:
an electronic overcurrent release; and
tripping magnets, adapted to trip a latch, when at least one of the electronic overcurrent release and a special signal causes closed switching contacts to be released, wherein the electronic overcurrent release includes a front control panel, accessible via a control panel of the power breaker, and wherein the tripping magnets are located on a side of a housing of the electronic overcurrent release that is remote from the front control panel.

4. The module as claimed in claim 3, wherein the tripping magnets include at least one of display and reset elements, visible on the front control panel of the electronic overcurrent release.

5. A low-voltage power breaker, comprising:
an electronic overcurrent release; and
means for tripping a latch when at least one of the electronic overcurrent release and a special signal causes closed switching contacts to be released, the electronic overcurrent release and the means for tripping being fit together to form a protective module, wherein the electronic overcurrent release includes a front control panel, accessible via a control panel of the power breaker, and wherein the means for tripping is located on a side of a housing of the electronic overcurrent release that is remote from the front control panel.

6. The low-voltage power breaker as claimed in claim 5, wherein the means for tripping include at least one of display and reset elements, visible on the front control panel of the electronic overcurrent release.
